(19) United States
(12) Patent Application Publication
(10) Pub. No.: US 2004/0083219 A1
(43) Pub. Date: Apr. 29, 2004

(54) Method and system for reducing code in an extensible markup language program

(75) Inventors: Jingkun Hu, Briarcliff Manor, NY (US); Luyin Zhao, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/279,548

(22) Filed: Oct. 24, 2002

(51) Int. Cl. G06F 7/00

(52) U.S. Cl. 707/100

(57) ABSTRACT

A method is directed to reducing code in a mark-up language program. The method provides for providing a first schema and second schema, analyzing the second schema for a node requirement, and identifying a portion of the first schema based on the node requirement. The method further provides for modifying the second schema with the identified portion of the first schema utilizing a uniform resource identifier format and validating the second schema. The step of providing the first schema may further include identifying an existing schema to be utilized, retrieving the existing schema, and storing the existing schema as the first schema. The uniform resource identifier format may be selected from either a uniform resource locator or a uniform resource name. The step of analyzing the second schema for a node requirement may include analyzing the second schema for a node symbol and a restriction symbol.

### FIELD OF THE INVENTION

In general, the invention relates to extensible markup language programming. More specifically, the invention relates to a method and system for reducing code within an extensible markup language program.

### BACKGROUND OF THE INVENTION

Extensible Markup Language (XML) was designed to improve functionality of the World Wide Web (WWW) by providing more flexible and adaptable information identification. XML is identified as extensible because it is not a fixed format, such as Hyper Text Markup Language (HTML). HTML is a single, predefined markup language. XML is a “metalanguage”, that is XML is a language for describing other languages. XML allows a user to design her own customized markup languages for an unlimited amount of documents. XML can be utilized in this manner because XML is written in Standard Generalized Markup Language (SGML), the international standard “metalanguage” for text markup systems (ISO 8879:1985).

XML was designed to allow straightforward use of SGML on the Web, such as defining document types, enabling simplified authorship and management of SGML-defined documents, and allowing ease of transmission and sharing of the documents across the Web. XML is described in the XML specification and defines a dialect of SGML. One of the goals in developing XML was to produce a generic SGML that would be received and processed on the Web, similar to HTML. Therefore, XML was designed, among other design characteristics, to allow for ease of implementation and interoperability with both SGML and HTML. XML was not designed solely for Web page application. XML was designed to be utilized to store many different types of information. An important XML use includes encapsulating information in order to pass the information between various computing systems that may otherwise not be capable of communicating.

XML allows groups or organizations to create their own customized markup applications for exchanging information in a domain, for example chemistry, electronics, finance, engineering, and the like. Each customized markup application is termed a specific XML Schema of the W3C XML Schema Definition Language. The XML Schema defines what the hierarchical structure, also referred to as tree, of XML documents would be and whether individual elements/attributes should possess predefined values, what constraints the XML documents carry, and the like.

Unfortunately, XML Schema while providing simple mechanisms for reusing schemas is not flexible enough to produce a similar schema, such as allowing a user to specify a fixed value for an element and then change the specific element in the tree. That is, instead of reusing the existing schema, the user is required to produce another schema to include duplicating all structure definitions above the changed element (for leaf elements, the whole schema tree is duplicated).

Simple mechanisms currently exist for reusing schemas and allow the reuse of small portions of the existing schema. FIG. 1a is a diagram of a block of code illustrating a conventional method for reusing schema. Line 110 of FIG. 1a illustrates an example of schema reuse by utilization of a “base” attribute. The “base” attribute allows the user to refer the base type definition. Utilization of the “base” attribute allows the user to derive another simple schema data types and add more restrictions to the “new” data types. Simple schema data types include String, Date, and the like. This mechanism also applies to complex types. A new complex type can be derived from an existing complex type.

FIG. 1b is a diagram of a block of code illustrating another conventional method for reusing schema. Line 128 of FIG. 1b illustrates a second example of schema reuse by utilization of a “group” attribute. Utilization of the “group” attribute allows the user to include a previously used piece of schema, contained within lines 120-125, within one or more locations of the schema.

FIG. 1c is a diagram of a block of code illustrating yet another conventional method for reusing schema. Line 130 of FIG. 1c illustrates a third example of schema reuse by utilization of an “include” attribute. Utilization of the “include” attribute allows the user to incorporate other schema files within the current schema.

FIG. 1d is a diagram of a block of code illustrating another conventional method for reusing schema. Line 140 of FIG. 1d illustrates a fourth example of schema reuse by utilization of an “abstract” attribute. Utilization of the “abstract” attribute allows the user to derive new schema types from an existing abstract schema type. When a type has an abstract attribute with a ‘true’ value, it means that there is no XML instance directly associated with this type.

Unfortunately, the above example reuse mechanisms provided by the current XML Schema standard are not flexible enough. For example, in order to specify a fixed value for an element (tree node) or to replace a definition for a sub-tree, in the XML document tree with an existing defined schema, the user must produce another XML schema and copy all structure definitions above the element from the existing schema. Present reuse mechanisms can not resolve this problem.

FIG. 2a is a diagram of a block of code, referred to with a filename of book.xsd, illustrating a conventional XML schema and referred to as schema 200. In FIG. 2a, the schema 200 illustrates how an example of an XML schema for “books” may be produced. The schema 200 example is a general constraint to XML documents representing books. That is, the XML schema of FIG. 2a would require any XML document utilizing the schema 200 to include data corresponding to elements within the schema 200.

FIG. 2b is a diagram of a block of code illustrating a conventional XML document and referred to as document 250. In FIG. 2b the document 250 is valid against the XML schema of FIG. 2a. That is, the XML document of FIG. 2b contains data that corresponds to element identifiers of schema 200. For example, line 270 of document 250 includes a name identifier of “Snoopy” corresponding with line 215 of schema 200 that includes a name element of “name” within the element name of “character” of line 212.

Each of the element identifiers must have a corresponding element identifier within the XML schema of FIG. 2a for the XML document of FIG. 2b to be valid. For example, line 210 of the XML schema of FIG. 2a includes an element with a name of “title” and defined, by type, as a “string.” Line 260 of the document 250 includes a title “Being a Dog is a Full Time Job” matching the requirement of the schema 200. Other identified lines of code within schema 200 of FIG. 2a are discussed below.

Unfortunately, if the user has as a goal to constrain all books since the 1^{st} of January 1950 (1950-1-1), the user is required to produce another “new” XML schema. FIG. 3a is a diagram of a block of code illustrating another conventional XML schema and referred to as schema 300. The schema 300 of FIG. 3a is produced with most of the previous schema 200 of FIG. 2a duplicated within the “new” XML schema of FIG. 3a.

The XML schema of FIG. 3a illustrates how an example of an XML schema for “books since January 1^{st} of 1950 (1950-1-1),” assuming all other elements are retained, may be produced. In FIG. 3a, the schema 300 is similar to the XML schema of FIG. 2a, with some exceptions.

Line 310 of the schema 300 renames the element name from “book” of line 207 of schema 200 to “special_book.” Line 311 of the schema 300 declares the complexType name “generic_book” of line 208 of schema 200 to be renamed “special_book.” Additionally, line 320 of schema 300 includes a declaration further defining line 217 of schema 200. The element name “since” of line 217 and defined, by type, as a “string” is further defined, in line 320, to include the type “date” as a fixed value of “1950-1-1.”

Therefore:

<xs:element name=“since” type=“xs:date”/>

of the XML Schema of FIG. 2a becomes:

<xs:element name=“since” type=“xs:date” fixed=“1950-1-1”/>

of the XML Schema of FIG. 3a.

Alternatively, the user may determine a need to redefine elements within the XML schema. Again, the user is required to produce another XML schema, for example a “new” XML schema of FIG. 3b. FIG. 3b is a diagram of a block of code illustrating yet another conventional XML Schema and referred to as schema 350. The XML schema of FIG. 3b is produced utilizing most of the previous XML schema of FIG. 2a. For example, the following “new” XML schema of FIG. 3b illustrates how an example of an XML schema for defining a new type may be produced. In schema 350, line 360 includes a new type, defined as “newType” for the element “qualification,” of line 218 of schema 200, thereby further defining the element.

In this example, the XML schema of FIG. 3b is similar to the XML schema of FIG. 2a. Line 360 of schema 350 redefines the type of element name “qualification” of line 218 of schema 200. Lines 360-370 further define additional elements within the type “newType” within element name “qualification” of FIG. 3b.

The above example XML schemas of FIGS. 3a and 3b illustrate modifications required for utilizing an existing XML schema, of FIG. 2a, for similar applications. The above examples of FIGS. 3a and 3b illustrate simplified situations and, if file size and labor resources for implementation are not a factor, are acceptable implementations of variations of an existing schema.

However, when large schemas with multi-level sub-trees are implemented a great amount of resources may be required for the implementation. For example, large schemas require increased memory utilization as well as programming time to duplicate already existing code.

It would be desirable, therefore, to provide a method and system that would overcome these and other disadvantages.

### SUMMARY OF THE INVENTION

The present invention is directed to a method and system for reducing code within an extensible markup language program. The invention provides for utilizing extensions within a new schema to import a portion of an existing schema into the new schema.

One aspect of the invention provides a method for reducing code in a mark-up language program by providing a first and second schema, analyzing the second schema for a node requirement, identifying a portion of the first schema based on the node requirement, modifying the second schema with the identified portion of the first schema utilizing a uniform resource identifier format, and validating the second schema.

In accordance with another aspect of the invention, a computer readable medium storing a computer program includes: computer readable code for providing a first and second schema; computer readable code for analyzing the second schema for a node requirement; computer readable code for identifying a portion of the first schema based on the node requirement; computer readable code for modifying the second schema with the identified portion of the first schema utilizing a uniform resource identifier format; and computer readable code for validating the second schema.

In accordance with yet another aspect of the invention, a computer program product in a computer usable medium for reusing a first schema to produce a second schema is provided. The computer program product in a computer usable medium includes means for providing a first and second schema. The computer program product in a computer usable medium further includes means for analyzing the second schema for a node requirement. Means for identifying a portion of the first schema based on the node requirement is also provided. The computer program product in a computer usable medium further includes means for modifying the second schema with the identified portion of the first schema utilizing a uniform resource identifier format, and means for validating the second schema.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1a is a diagram of a block of code illustrating a conventional method for reusing schema;

FIG. 1b is a diagram of a block of code illustrating another conventional method for reusing schema;

FIG. 1c is a diagram of a block of code illustrating yet another conventional method for reusing schema;

FIG. 1d is a diagram of a block of code illustrating another conventional method for reusing schema;

FIG. 2a is a diagram of a block of code illustrating a conventional XML schema;

FIG. 2b is a diagram of a block of code illustrating a conventional XML document;

FIG. 3a is a diagram of a block of code illustrating another conventional XML schema;

FIG. 3b is a diagram of a block of code illustrating yet another conventional XML schema;

FIG. 4 is a flow diagram depicting an exemplary embodiment of code on a computer readable medium in accordance with the present invention;

FIG. 5a is an exemplary embodiment of code on a computer readable medium in accordance with the present invention; and

FIG. 5b is another exemplary embodiment of code on a computer readable medium in accordance with the present invention.

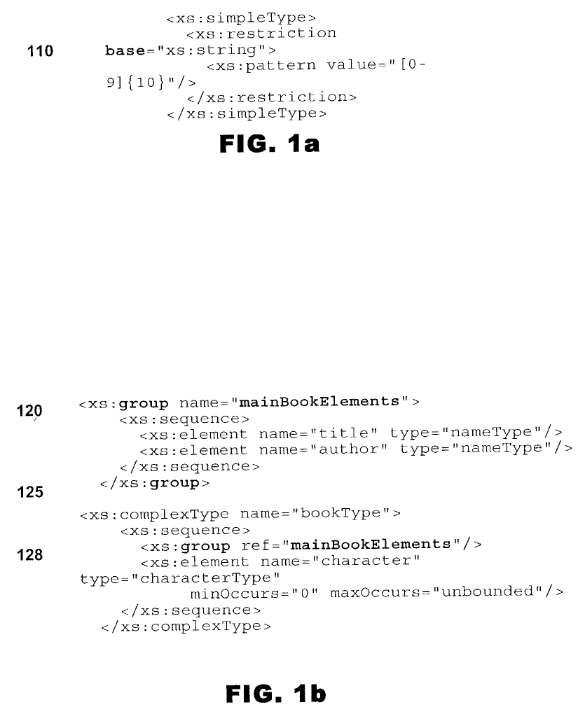

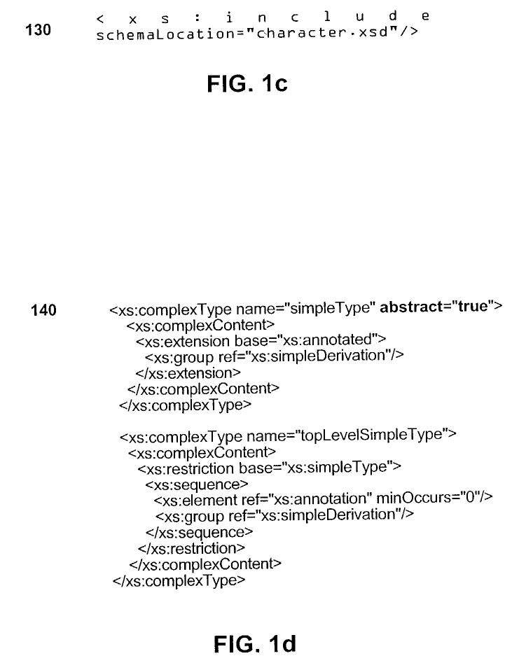

### DETAILED DESCRIPTION OF THE PRESENTLY PREFERRED EMBODIMENT

The present invention relates to extensible markup language programming and more particularly to a method and system for reducing code within an extensible markup language program. It is an object of the invention to produce a customized schema utilizing portions of an existing schema that requires utilization of considerably less assets.

The invention provides for utilizing extensions to allow reuse of an existing schema to enhance a newly created schema. The present invention includes providing an existing schema and a new schema, analyzing the new schema for a node requirement, identifying a portion of the existing schema based on the node requirement, modifying the new schema with the identified portion of the existing schema utilizing a uniform resource identifier format, and validating the new schema.

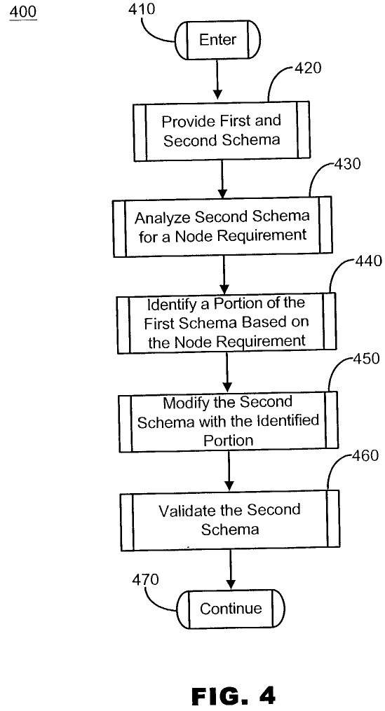

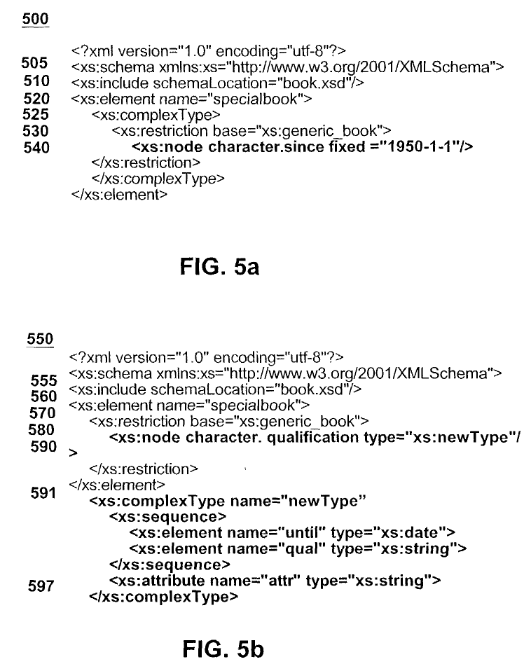

FIG. 4 is a flow diagram depicting an exemplary embodiment of code on a computer readable medium in accordance with the present invention. FIG. 4 details an embodiment of a method 400 for reducing code within an extensible markup language program. Method 400 may utilize code detailed in FIGS. 5a and 5b, below.

Method 400 begins at block 410 where a user determines a need to produce a customized schema utilizing portions of an existing schema whereby the customized schema will have a reduced amount of code. Method 400 then advances to block 420.

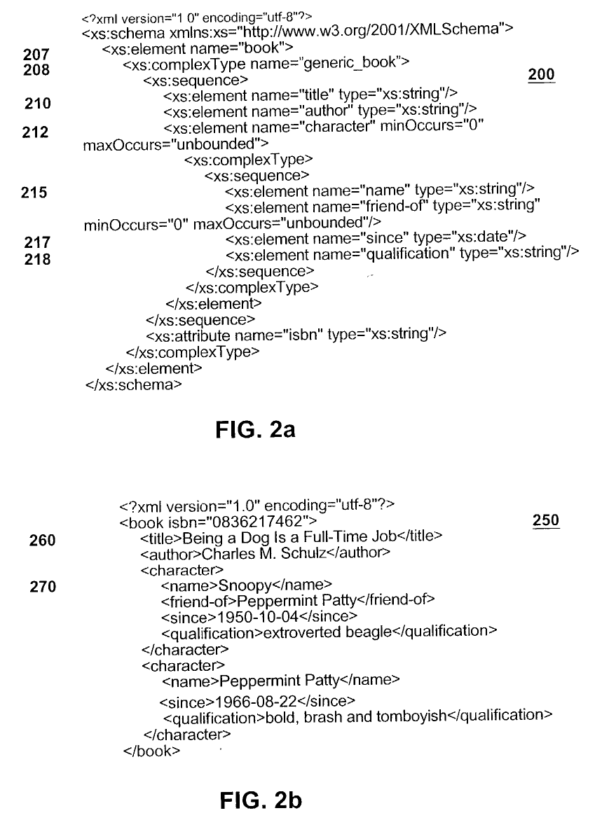

At block 420, the existing schema and the customized schema are provided. In one embodiment and detailed in FIG. 5a below, the customized schema is implemented as a simplified schema 500 and the existing schema is implemented as schema 200 of FIG. 2a, above. In another embodiment and detailed in FIG. 5b below, the customized schema is implemented as a simplified schema 550 and the existing schema is implemented as schema 200 of FIG. 2a, above. Method 400 then advances to block 430.

At block 430, the customized schema is analyzed for a node requirement. The node requirement identifies a portion of the existing schema that the customized schema will import and utilize. In one embodiment, the node requirement is implemented as lines 530-540 of FIG. 5a, below. In another embodiment, the node requirement is implemented as lines 580-590 of FIG. 5b, below. Method 400 then advances to block 440.

At block 440, the portion of the existing schema that will be utilized by the customized schema is identified utilizing the node requirement of the customized schema. In one embodiment, lines 530-540 of FIG. 5a identify a portion of schema 200 of FIG. 2a that will be utilized. In this embodiment, lines 530-540 of FIG. 5a identify lines 208-217 to be imported into schema 500 of FIG. 5a.

In another embodiment, lines 580-590 of FIG. 5b identify another portion of schema 200 of FIG. 2a that will be utilized. In this embodiment, lines 580-590 of FIG. 5b identify lines 208-218 to be imported into schema 550 of FIG. 5b. Method 400 then advances to block 450.

At block 450, the customized schema is modified to include the identified portions of existing schema. Method 400 then advances to block 460.

At block 460, the customized schema is validated. Validation ensures that the modified customized schema will operate within a desired operating system. Method 400 then advances to block 470 where it returns to standard programming.

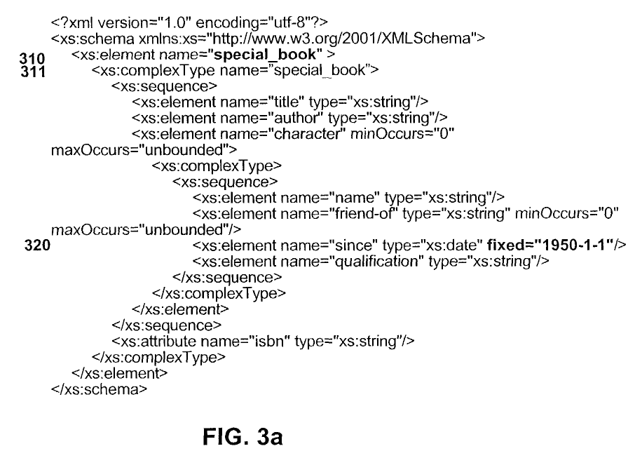

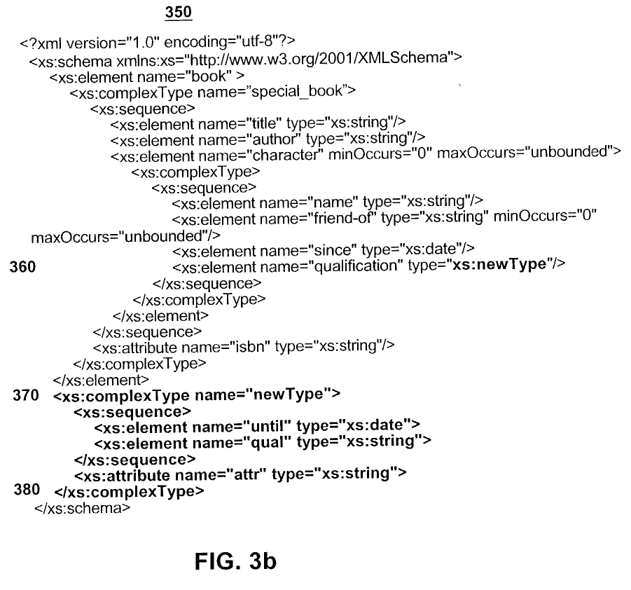

FIG. 5a is an exemplary embodiment of code on a computer readable medium in accordance with the present invention. FIG. 5a includes a simplified schema 500 that is based on the schema of FIG. 2a and accomplishes the same result as the schema in FIG. 3a above. In FIG. 5a, new schema 500 includes line 505 that specifies a type of schema in use. In one example, the XML Schema of 2001 is utilized.

New schema 500 further includes line 510 that identifies a particular schema to import. The imported schema is placed in a memory location (not shown). In an example, an include attribute schemaLocation identifies “book.xsd” of FIG. 2a as the existing schema to be utilized. The imported schema is now a part of the new schema 500 of FIG. 5a in memory (not shown).

New schema 500 additionally includes line 520 and 525 that define a schema element within the new schema 500. In an example, the element is defined with a name of “specialbook” and as a complexType. New schema 500 further includes line 530 that defines a restriction base utilized and referred to as a restriction symbol. In one embodiment, the restriction symbol is implemented as a restriction (as shown). In another embodiment, the restriction symbol is implemented as an extension. In an example, the restriction base is defined as “generic_book” of the existing schema 200 of FIG. 2a.

New schema 500 additionally includes line 540 that defines a specific portion of the restriction base, identified in line 530 and described above, that schema 500 will operate on. This attribute is referred to as a node symbol. In an example and referring to line 530 of FIG. 5a, the node symbol identifies the element name “character,” further identifies the element name “since,” and redefines the type from a “string,” line 217 of FIG. 2a, to a fixed attribute having a value of “1950-1-1.” In one embodiment, the combination of the restriction symbol and the node symbol is referred to as a node requirement.

The node symbol utilizes a universal resource identifier format. In one embodiment, the universal resource identifier format is implemented as a uniform resource locator format. In another embodiment, the universal resource identifier format is implemented as a uniform resource name format.

The schema 500 of FIG. 5a represents a reduced amount of code required to accomplish the same result as the schema of FIG. 3a. The schema of FIG. 3a utilizes 22 lines of code to accomplish its requirement while schema 500 of FIG. 5a utilizes 10 lines of code to accomplish the same requirement. The result is a reduction of over 50% in the code necessary to accomplish the required result.

FIG. 5b is another exemplary embodiment of code on a computer readable medium in accordance with the present invention. FIG. 5b includes a simplified schema 550 that is based on the schema of FIG. 2a and accomplishes the same result as the schema in FIG. 3b above. In FIG. 5b, new schema 550 includes line 555 that specifies a type of schema in use. In one example, the XML Schema of 2001 is utilized.

New schema 550 further includes line 560 that identifies a particular schema to import. The imported schema is placed in a memory location (not shown). In an example, an include attribute schemaLocation identifies “book.xsd” of FIG. 2a as the existing schema to be utilized. The imported schema is now a part of the new schema 550 of FIG. 5a in memory (not shown).

New schema 550 additionally includes line 570 that defines a schema element within the new schema. In an example, the element is defined with a name of “specialbook”. New schema 550 further includes line 580 that defines a restriction base utilized and is referred to as a restriction symbol. In one embodiment, the restriction symbol is implemented as a restriction (as shown). In another embodiment, the restriction symbol is implemented as an extension. In an example, the restriction base is defined as “generic_book” of the existing schema 200 of FIG. 2a.

New schema 550 additionally includes line 590 that defines a specific portion of the restriction base. Line 590 of schema 550 functions similarly to line 530 of schema 500 described above. This attribute is referred to as a node symbol as well. In an example and referring to FIG. 5b, the node symbol identifies the element name “character,” further identifies the element name “qualification,” and redefines the type from a “string,” line 218 of FIG. 2a, to type attribute having a value of “newType.” In one embodiment, the combination of the restriction symbol and the node symbol is referred to as a node requirement. New schema 450 further includes lines 491-497 that define additional elements and attributes within the complextype name “newType.”

The schema 450 of FIG. 4b represents a reduced amount of code required to accomplish the same result as the schema of FIG. 3b. The schema of FIG. 3b utilizes 29 lines of code to accomplish its requirement while schema 450 of FIG. 4b utilizes 15 lines of code to accomplish the same requirement. The result is a reduction of almost 50% in the code necessary to accomplish the required result.

Once the new schema has identified the portion of the existing for reuse the schema is validated for use. Validation is conducted with any one of the validation programs, for example a parser, readily available in the art.

The above-described methods and implementation for reducing code within an extensible markup language program are example methods and implementations. These methods and implementations illustrate one possible approach for reducing code within an extensible markup language program. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

We claim:

1. A method for reducing code in a mark-up language program, the method comprising:
providing a first and second schema;
analyzing the second schema for a node requirement;
identifying a portion of the first schema based on the node requirement;
modifying the second schema with the identified portion of the first schema utilizing a uniform resource identifier format; and
validating the second schema.

2. The method of claim 1 wherein providing the first schema comprises:
identifying an existing schema to be utilized;
retrieving the existing schema; and
storing the existing schema as the first schema.

3. The method of claim 1 wherein the uniform resource identifier format is selected from a group consisting of: a uniform resource locator and a uniform resource name.

4. The method of claim 1 wherein analyzing the second schema for a node requirement comprises:
analyzing the second schema for a restriction symbol;
analyzing the second schema for a node symbol; and
identifying the restriction symbol and the node symbol within the second schema.

5. The method of claim 4 wherein the node symbol within the second schema is expressed as a namespace and a tag identifying an element within a sub-tree.

6. The method of claim 1 wherein assigning an identifier to a portion of the first schema based on the node requirement comprises:
identifying a restriction symbol within the second schema;
identifying at least one node symbol within the second schema; and
identifying the portion of the first schema based on the restriction symbol and the node symbol.

7. The method of claim 6 wherein the node symbol within the second schema is expressed a namespace and a tag identifying an element within a sub-tree.

8. The method of claim 6 wherein the restriction symbol within the second schema is expressed as a restriction.

9. The method of claim 6 wherein the restriction symbol within the second schema is expressed as an extension.

10. The method of claim 1 wherein validating the second schema comprises:
applying a parser to the second schema.

11. A computer readable medium storing a computer program comprising:
computer readable code for providing a first and second schema;
computer readable code for analyzing the second schema for a node requirement;
computer readable code for identifying a portion of the first schema based on the node requirement;
computer readable code for modifying the second schema with the identified portion of the first schema utilizing a uniform resource identifier format; and
computer readable code for validating the second schema.

12. The computer readable medium of claim 11 wherein providing the first schema comprises:
computer readable code for identifying an existing schema to be utilized;
computer readable code for retrieving the existing schema; and
computer readable code for storing the existing schema as the first schema.

13. The computer readable medium of claim 11 wherein the uniform resource identifier format is selected from a group consisting of: a uniform resource locator and a uniform resource name.

14. The computer readable medium of claim 11 wherein analyzing the second schema for a node requirement comprises:
computer readable code for analyzing the second schema for a node symbol; and
computer readable code for identifying a node symbol within the second schema.

15. The computer readable medium of claim 14 wherein the node symbol within the second schema is expressed a namespace and a tag identifying an element within a sub-tree.

16. The computer readable medium of claim 11 wherein assigning an identifier to a portion of the first schema based on the node requirement comprises:
computer readable code for identifying a node symbol within the second schema;
computer readable code for identifying a restriction symbol within the second schema; and
computer readable code for identifying a portion of the first schema based on the node symbol and the restriction symbol.

17. The computer readable medium of claim 16 wherein the node symbol within the second schema is expressed a namespace and a tag identifying an element within a sub-tree.

18. The computer readable medium of claim 16 wherein the restriction symbol within the second schema is expressed as a restriction.

19. The computer readable medium of claim 16 wherein the restriction symbol within the second schema is expressed as an extension.

20. The computer readable medium of claim 11 wherein validating the second schema comprises:
computer readable code for applying a parser to the second schema.

21. A computer program product in a computer usable medium for reusing a first schema to produce a second schema, comprising:
means for providing a first and second schema;
means for analyzing the second schema for a node requirement;
means for identifying a portion of the first schema based on the node requirement;
means for importing the identified portion of the first schema into the second schema utilizing a uniform resource identifier format; and
means for validating the second schema, the second schema including the imported portion of the first schema.
